(19) United States
(12) Patent Application Publication
(10) Pub. No.: US 2010/0039553 A1
(43) Pub. Date: Feb. 18, 2010

(54) Camera module

(75) Inventors: So Rim Kim, Suwon-si (KR); Dong Kyun Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/292,844

(22) Filed: Nov. 26, 2008

(30) Foreign Application Priority Data
Aug. 13, 2008 (KR) 10-2008-0079424

(51) Int. Cl. H04N 5/225

(52) U.S. Cl. 348/374; 348/E05.024

(57) ABSTRACT

The present invention relates to a camera module including a substrate; a housing which is coupled to the substrate and includes a support unit extended to an inside of a lower part and a shaft insertion groove at one side of the support unit; a guide shaft vertically coupled inside the housing by inserting a lower end portion into the shaft insertion groove; a conductive pattern extended from a lower end portion of the housing to a bottom surface of the support unit; an image sensor closely coupled to the bottom surface of the support unit by being electrically connected to the conductive pattern; a lens barrel fixed to an upper part of the housing by coupling a lens inside; and a movable lens barrel vertically moved along the guide shaft by mounting lens inside.

### CROSS-REFERENCE TO RELATED APPLICATIONS

This application claims the benefit of Korean Patent Application No. 10-2008-0079424 filed with the Korea Intellectual Property Office on Aug. 13, 2008, the disclosure of which is incorporated herein by reference.

### BACKGROUND OF THE INVENTION

1. Field of the Invention

The present invention relates to a camera module; and, more particularly, to a camera module capable of preventing a tilt of an optical axis between an image sensor and a lens by minimizing a position tolerance of a shaft insertion groove of a housing and a pattern formed at a lower end of the housing.

2. Description of the Related Art

In general, a CCM(Compact Cameral Module) is small and is applied to a diversity of IT(Information Technology) equipment including a potable mobile communication device such as a camera phone, a PDA (Personal Digital Assistant), and a smart phone and a toy camera and recently, the release of devices mounting small cameral modules according to various consumers' tastes has been gradually increasing.

The camera module has been manufactured by using an image sensor such as a CCD(Charge-Coupled Device) or a CMOS(Complementary Metal-Oxide Semiconductor) as a primary component. The camera module condenses an image of a subject through the image sensor and stores the image as data on a memory in equipment, wherein the stored data is displayed with a picture through a display medium such as an LCD(Liquid Crystal Display) monitor or a PC(Personal Computer) monitor in the equipment.

Particularly, according to the consumers' tastes, a camera module with functions such as AF(Auto-Focusing) and zoom adjustment has been demanded and therefore precise design and assembly of components in comparison with a general camera module has been needed.

The general camera module includes a substrate, an image sensor, and an optical unit which is coupled onto the substrate, wherein with the image sensor mounted on a top surface of the substrate, the optical unit having a housing and a lens barrel is coupled to an upper part of the image sensor.

At this time, the image sensor is electrically coupled by closely adhering a conductive pattern formed on the top surface of the substrate to pads of the image sensor or electrically coupled to pads formed on the top surface of the substrate through wire bonding.

Further, in the conventional camera module, when a lower end portion of the housing constituting the optical unit is coupled to the substrate, a coupling position of the optical unit and the substrate is determined by inserting a boss formed at the lower end portion of the housing into a through hole of a corner portion of the substrate.

Meanwhile, when a lens driving module for auto-focusing is mounted to the optical unit coupled to an upper part of the substrate, a movable lens of the lens driving module is supported through guide shafts.

At this time, mounting precision of the movable lens is determined through the guide shafts, wherein the guide shafts are mounted at both sides in the housing and positions thereof are determined by coupling the boss formed at the lower end portion of the housing into the through hole.

The conventional camera module constructed as described above should match a center of the image sensor mounted to the substrate with an optical axis of a lens mounted inside the housing, particularly, in the optical unit mounting the lens driving module, the lens is moved vertically, and thus more precise assembly tolerance is needed.

However, because in the conventional camera module, the position of the housing coupled through the through hole of the substrate is determined and the position of the movable lens coupled inside the housing is determined with respect to the image sensor mounted through the wire bonding to the pads on the substrate, it is difficult to precisely assemble the camera module to match the optical axis between the image sensor and the lens and an increased assembly tolerance causes a tilt of the optical axis.

### SUMMARY OF THE INVENTION

The present invention has been invented in order to overcome the above-described problems of the conventional camera module, it is, therefore, an object of the present invention to provide a camera module capable of minimizing an assembly tolerance between an image sensor and a lens by mounting the image sensor electrically connected through a conductive pattern to a lower part of a housing and minimizing a position tolerance of a guide shaft mounted in the housing and the conductive pattern.

To achieve the object, there is provided a camera module including a substrate; a housing which is coupled to the substrate and includes a support unit extended to an inside of a lower part; a conductive pattern extended from a lower end portion of the housing to a bottom surface of the support unit; an image sensor closely coupled to the bottom surface of the support unit by being electrically connected to the conductive pattern; and a lens barrel fixed to an upper part of the housing.

The substrate may be a printed circuit board or a ceramic substrate and the lower end portion of the housing is received on a top surface of the substrate.

The housing includes guide shafts at both sides inside and a plurality of movable lens units are mounted to the guide shafts at predetermined intervals.

The guide shaft is inserted into a shaft insertion groove formed at one side of the support unit in the housing and the movable lens units vertically moved along the guide shafts may be driven by a driving method using an electromagnetic motor, a lens driving method using a piezoelectric element, and a VCA(Voice Comb Actuator) driving method using an electromagnetic wave.

Further, one end of the conductive pattern is extended to the bottom surface of the support unit along an inner side face of the housing by being interposed between the lower end portion of the housing and the top surface of the substrate and an extended end side of the conductive pattern extended to the bottom surface of the support unit is coupled to a top surface of the image sensor to be electrically connected to each other.

Meanwhile, on the top surface of the support unit, an IR filter glass is mounted to block excessive infrared rays included in incident rays impinged through a lens in the lens barrel fixed to an upper end of the housing.

In accordance with the present invention, the camera module is capable of implementing high precision assembly by being assembled to minimize assembly tolerances of the guide shafts and the image sensor with respect to the conductive pattern formed at the lower part of the housing when assembling the camera module by attaching the image sensor to the lower part of the housing including the lens driving module for auto-focusing or zoom adjustment inside and closely adhering the housing to the top surface of the substrate.

### BRIEF DESCRIPTION OF THE DRAWINGS

These and/or other aspects and advantages of the present general inventive concept will become apparent and more readily appreciated from the following description of the embodiment, taken in conjunction with the accompanying drawing of which:

FIG. 1 is a cross-sectional view showing a camera module in accordance with an embodiment of the present invention.

### DETAILED DESCRIPTION OF THE PREFERRED EMBODIMENTS

A matter regarding to an operation effect including a technical configuration to achieve the object of a camera module in accordance with the present invention will be clearly appreciated through the following detailed description with reference to the accompanying drawing illustrating preferable embodiment of the present invention.

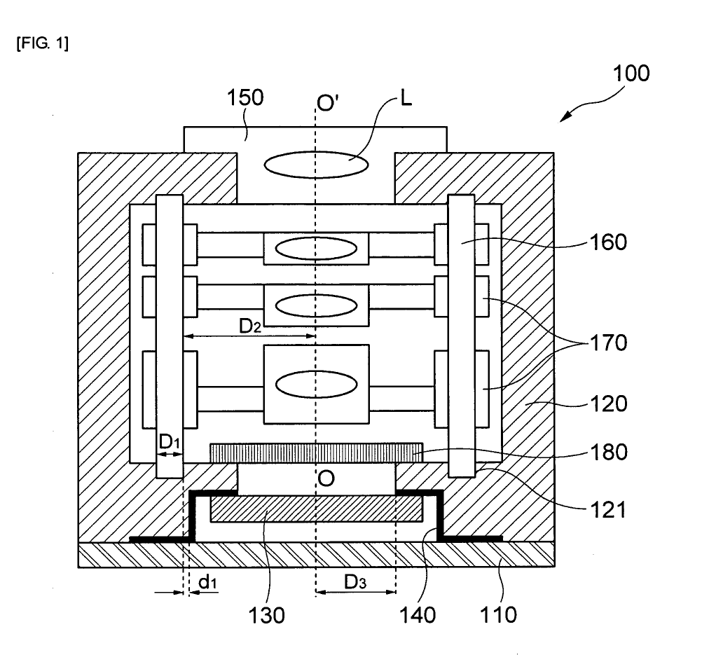

First of all, FIG. 1 is a cross-sectional view showing a camera module in accordance with an embodiment of the present invention.

As shown in FIG. 1, in accordance with the embodiment of the present invention, a cameral module 100 includes a plate-shaped substrate 110, a housing 120 coupled to the substrate 110, conductive patterns 140 formed at a lower end portion of the housing 120 and an image sensor 130 coupled to a lower part of the housing 120 by being electrically connected through the conductive patterns 140.

The substrate 110 is a square plate-shaped printed circuit board or ceramic substrate and includes a plurality of pads(not shown) for electric connection at a circumferential portion.

The housing 120 coupled to an upper part of the substrate 110 is formed in a hollow shape and a lens barrel 150 mounting a lens L is fixed to an opening of an upper end of the housing 110. Further, at a lower side of the housing 120, a support unit 122 is extended by protruding toward the inside of the housing 120.

On a bottom surface of the support unit 122 as a portion where the image sensor 130 is mounted, the image sensor 130 is closely coupled by a flip chip method and a light receiving portion(not shown) formed at a central portion of the image sensor 130 is to be exposed to an opened portion of the support unit 122.

Therefore, light introduced into the housing 120 through the lens L of the lens barrel 150 coupled to an upper part of the housing 120 is impinged to the light receiving portion of the image sensor 130 coupled to the support unit through the housing 120 and the light condensed to the light receiving portion is converted into an electrical signal in the image sensor 130 to be generated as image data.

Meanwhile, the image sensor 130 mounted to the support unit 122 transmits the converted image data outside by being electrically connected to the substrate 110 through the conductive patterns 140 formed along an inner wall surface of the lower end portion of the housing 120.

One ends of the conductive patterns 140 are formed at the lower end portion of the housing 120 and the other ends thereof are formed to the bottom surface of the support unit 122 be being extended along the inner wall surface of the housing 120.

At this time, the one ends of the conductive patterns 140 are connected to pads formed on the housing 120 and the other ends thereof are electrically connected to the image sensor 130 closely coupled to the bottom surface of the support unit 122.

Further, an IR filter glass 180 is mounted on a top surface of the support unit 122, wherein the IR filter glass 180 may include an IR coating layer on one surface or be formed in an IR film stacked shape to block infrared rays included in the light introduced into the housing 120 through the lens L.

Meanwhile, inside the housing 120, a pair of guide shafts 160 are installed and a plurality of movable lens barrels 170 which are vertically moved along the guide shafts 160 and perform an auto-focusing function and a zoom function are mounted.

The pair of guide shafts 160 are vertically coupled to shaft insertion grooves 121 formed at one side of the support unit 122 in the housing 120 and the movable lens barrel 170 perform the zoom function and the auto-focusing function through distance adjustment of the lens L and the image sensor 130 while being vertically moved on the guide shafts 160.

At this time, the movable lens barrels 170 may vertically be moved along the guide shafts 160 by a driving method using an electromagnetic motor, a driving method using a piezoelectric element, a driving method using an electromagnetic wave, and so on.

As described above, if the movable lens barrels 170 are coupled inside the housing 120, an optical axis of the lens L should be always matched with a center of the image sensor 130 in movement of the movable lens barrels 170 and therefore the movable lens barrels 170 should be precisely assembled.

In order to precisely assemble the movable lens barrels 170, positions of the guide shafts supporting them should be exactly specified and so the shaft insertion grooves 121 into which the guide shafts 160 are inserted are designed to have the minimal tolerance with respect to the conductive patterns 140 formed on the housing.

To accomplish this, the shaft insertion grooves 121 are designed to minimize the position tolerance d, with respect to the conductive patterns 140 formed at the lower part of the housing 120. That is, the shaft insertion grooves 121 are formed to have the position tolerance d₁ within ±0.05 mm to the conductive patterns 140 formed on the inner wall surface of the housing 120 by being bent at the lower end portion of the housing 120 and the guide shafts 160 are vertically inserted into the shaft insertion grooves 121 to have the minimal tolerance.

In other words, the camera module 100 assembled in accordance with the above embodiment is designed so that a coupling tolerance D₁ of the guide shaft 160 inserted into the shaft insertion groove 121 is ±0.01 mm, an assembly tolerance for a distance D₂ from a center O′ of a lens in the movable lens barrel 170 to the guide shaft 160 is ±0.01 mm and an assembly tolerance for a distance D₃ from the center O of the image sensor to the conductive pattern 140 is ±0.05 mm.

At this time, the position tolerance of the center O′ of the lens and the center O of the image sensor is controlled to less than 0.12 mm after finally assembling the camera module according to the above-mentioned tolerance information by designing the shaft insertion grooves 121 to which the guide shafts 160 are coupled to have the tolerance of less than ±0.05 mm with respect to the conductive patterns 140.

Accordingly, the camera module of the present invention is capable of minimizing the position tolerance of the center O of the lens and the center O′ of the image sensor by removing a position tolerance caused when in the conventional camera module, a boss of a housing is coupled to a substrate by attaching an image sensor to the substrate by mounting the image sensor 130 to the support unit 122 extended to the inside of the housing 120 and electrically connecting the image sensor 130 through the conductive patterns 140 extended along the lower end portion of the housing 120, thereby preventing deterioration of resolution due to the tilt of the optical axis.

That is, the camera module can be assembled at very high precision by minimizing the tolerance by determining a mounting position of the image sensor 130 and coupling positions of the guide shafts 160 supporting the movable lens barrels 170 with respect to the conductive patterns 140 formed at the lower end portion of the housing 120.

As described above, in accordance with the present invention, the camera module is capable of implementing high precision assembly by being assembled to minimize an assembly tolerance of the image sensor and the lens with respect to the conductive patterns formed at the lower part of the housing, thereby minimizing the optical tilt between the image sensor and the lens and improving optical resolution.

As described above, although a few preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A camera module comprising:
a substrate;
a housing which is coupled to the substrate and includes a support unit extended to an inside of a lower part;
a conductive pattern extended from a lower end portion of the housing to a bottom surface of the support unit;
an image sensor closely coupled to the bottom surface of the support unit by being electrically connected to the conductive pattern; and
a lens barrel fixed to an upper part of the housing by coupling a lens inside.

2. The camera module of claim 1, wherein the substrate is a printed circuit board or a ceramic substrate.

3. The camera module of claim 1, wherein one end of the conductive pattern is electrically connected to a pad formed on a top surface of the substrate and the other end thereof is electrically connected to a pad formed on the image sensor by being extended to a bottom surface of the support unit.

4. A camera module comprising:
a substrate;
a housing which is coupled to the substrate and includes a support unit extended to an inside of a lower part and a shaft insertion groove at one side of the support unit;
a guide shaft vertically coupled inside the housing by inserting a lower end portions into the shaft insertion groove;
a conductive pattern extended from a lower end portion of the housing to a bottom surface of the support unit;
an image sensor closely coupled to the bottom surface of the support unit by being electrically connected to the conductive pattern;
a lens barrel fixed to an upper part of the housing by coupling a lens inside; and
a movable lens barrel vertically moved along the guide shaft by mounting a lens inside.

5. The camera module of claim 4, wherein the substrate is a printed circuit board or a ceramic substrate.

6. The camera module of claim 4, wherein one end of the conductive pattern is electrically connected to a pad formed on a top surface of the substrate and the other end thereof is electrically connected to a pad formed on the image sensor by being extended to a bottom surface of the support unit.

7. The camera module of claim 4, wherein the movable lens barrel is driven by any one selected from a group consisting of a driving method using an electromagnetic motor, a driving method using a piezoelectric element, and a VCA(Voice Comb Actuator) driving method using an electromagnetic wave.

8. The camera module of claim 4, wherein the shaft insertion groove is designed to include a position tolerance of less than ±0.05 mm with respect to the conductive pattern extended to an inner wall surface by being bent at the lower end portion of the housing.

9. The camera module of claim 4, at an upper part of the support unit of the housing, an IR filter glass is mounted to block excessive infrared rays included in incident rays impinged into the housing.
